(19) United States
(12) Patent Application Publication
(10) Pub. No.: US 2025/0018835 A1
(43) Pub. Date: Jan. 16, 2025

(54) METHOD FOR OPERATING AN ADJUSTING SYSTEM FOR AN INTERIOR SPACE OF A MOTOR VEHICLE

(71) Applicant: Brose Fahrzeugteile GmbH SE & Co. Kommanditgesellschaft, Bamberg, Bamberg (DE)

(72) Inventors: Matthias Gempel, Bamberg (DE); Thomas Weingaertner, Lichteneiche (DE)

(21) Appl. No.: 18/572,858

(22) PCT Filed: Jun. 24, 2022
(86) PCT No.: PCT/EP2022/067313

§ 371 Date: Dec. 21, 2023

(30) Foreign Application Priority Data
Jun. 25, 2021 (DE) 10 2021 116 553.9

(51) Int. Cl. B60N 2/02; B60N 2/00

(52) U.S. Cl. CPC B60N 2/0278; B60N 2/0027; B60N 2/0248; B60N 2220/10

(57) ABSTRACT

A method for operating an adjustment system, the adjustment system comprising a motor-adjustable interior element for receiving a person, the motor-adjustable interior element being adjustable between different configurations by way of adjustment kinematics by a drive arrangement with at least one actuator, a control arrangement being provided. The control arrangement has a person model for the person received by the motor-adjustable interior element, and also an interior element model representing the interior element geometry and the adjustment kinematics of the motor-adjustable interior element, that the body configurations of the person that result from a motorized adjustment of the interior element are predicted by the control arrangement on the basis of the person model and the interior element model, and that the control in the adjustment routine is implemented by the control arrangement while complying with a comfort specification for the resulting body configurations.

### CROSS-REFERENCE TO RELATED APPLICATIONS

This application is a national stage application under 35 U.S.C. 371 of International Patent Application Serial No. PCT/EP2022/067313, entitled “Method for Operating an Adjusting System for an Interior Space of a Motor Vehicle,” filed Jun. 24, 2022, which claims priority from German Patent Application No. DE 10 2021 116 553.9, filed Jun. 25, 2021, the disclosure of which is incorporated herein by reference.

### FIELD OF THE TECHNOLOGY

Embodiments relate to a method for operating an adjustment system for an interior of a motor vehicle, to a control arrangement for operating an adjustment system, to a motor vehicle for carrying out such a method according to the disclosure, and to a computer program product and a computer-readable medium.

### BACKGROUND

In order to increase the comfort, motor vehicles are equipped with adjustment systems that allow motorized adjustment of interior elements. Interior elements are understood as meaning, inter alia, seats, seat benches, consoles, operator control elements, panels, screens, trays, lighting elements, interior mirrors, trim panels or the like, which can be assigned to the interior of the motor vehicle.

The operator of the motor vehicle can, inter alia, trigger a motorized adjustment manually and in particular use preset configurations of interior elements in which an automatic adjustment is intended to be carried out. Examples of such configurations include different seat positions, such as upright seat backs, reclining positions with lowered seat backs, or a conference configuration with mutually facing seats in the case of a plurality of seats.

The known method (DE 10 2019 209 740 A1), on which some embodiments are based, uses an interior sensor arrangement in order, during the adjustment, not to fall short of a minimum distance between the interior element and a further object.

It is additionally known (DE 10 2020 121 379 A1) to use the motorized adjustment of interior elements for reaction to vehicle movements. In this case, lowering or tilting movements that occur during travel can be compensated for by way of the adjustment of the seat in order to achieve an improvement in comfort and to prevent travel or motion sicknesses from occurring.

However, adjustment systems of modern motor vehicles, in particular also of semi-autonomous or autonomous motor vehicles, may have adjustable interior elements with complex adjustment kinematics. One challenge here is that the motorized movement sequence of the interior element may also have a disadvantageous effect on the comfort of the operator of the motor vehicle.

### SUMMARY

The problem on which various embodiments are based is to design and develop the method for operating an adjustment system in such a way that the comfort and the safety for the operator during the adjustment are improved further.

The above problem is solved in the case of a method for operating an adjustment system of a motor vehicle according to various embodiments disclosed herein.

Various embodiments have recognized that besides the end configuration of the interior element, the movement sequence during the motorized adjustment may also have a disadvantageous effect on the comfort of the operator. Inter alia, intermediate configurations of the interior element that are traversed in the adjustment routine may cause the operator to adopt uncomfortable postures. In the adjustment routine, velocities or accelerations that are found to be unpleasant may also act on the operator.

What is essential, in some embodiments, is the fundamental consideration that the effect of the adjustment on the operator can be predicted by way of suitable modelling. On the basis of the prediction, the control in the adjustment routine can be performed in such a way that undesired effects on the operator do not occur.

Specifically, it is proposed that the control arrangement has a person model for the person received by the motor-adjustable interior element, said person model representing the body geometry and the body kinematics of the person, and also an interior element model representing the interior element geometry and the adjustment kinematics of the motor-adjustable interior element, that the body configurations of the person that result from a motorized adjustment of the interior element are predicted by means of the control arrangement on the basis of the person model and the interior element model, and that the control in the adjustment routine is implemented by means of the control arrangement while complying with a comfort specification for the resulting body configurations.

In various embodiments, a path planning routine implemented by means of the control arrangement is provided, in which an adjustment path while complying with the comfort specification is determined on the basis of the interior element model. In the path planning routine, comfort can be optimized during the adjustment, particularly if a plurality of possible adjustment paths are present. Probabilistic path planning methods have proved to be particularly suitable here, whereby a substantial optimization in conjunction with comparatively low computational complexity is achieved in many cases. The path planning routine also allows the adjustment path to be determined while taking account of further constraints, which is the subject matter of various embodiments.

According to various embodiments the comfort specification concerns a predicted body parameter. Inter alia, specific body configurations found to be unpleasant can thereby be avoided in a simple manner in the adjustment routine.

Likewise, according to various embodiments the comfort specification can be defined in relation to interaction parameters between body and at least one object, in particular the motor-adjustable interior element. By way of example, excessive friction effects that occur during the adjustment can be avoided.

In various particularly easily implementable embodiments, the comfort specification contains at least one threshold value to be complied with. Likewise, the comfort specification can concern the optimization of an assigned comfort weighting, which increases the flexibility in the path planning, for example.

According to various embodiments the person model and/or the comfort specification can be stored in a person profile individually for the operator of the motor vehicle.

Further flexibility in the adjustment routine arises, in various embodiments, by means of an end configuration specification with different allowed end configurations, thus enabling further optimization of the adjustment comfort.

Various embodiments relate to collision checking in the path planning routine, whereby the path planning routine determines a collision-free adjustment path under the comfort specification. Some embodiments include the use of an interior sensor arrangement, which is generally provided for detecting objects in the interior. In various embodiments, the interior sensor arrangement also allows monitoring of the motor-adjustable interior element for determining the configuration.

In various embodiments, according to which an identification routine allows the detection of different interior elements. Consequently, the adjustment system can be modular and can permit different combinations of the interior of one type of vehicle. The adjustment system can also be modified, in particular even during the operation of the motor vehicle, by adding, replacing or removing interior elements.

In various embodiments, predefinable master configurations for the adjustment kinematics and master adjustment paths between master configurations are used in the adjustment routine. This reduces the computational complexity, and at the same time comfort can be further optimized. The operator can also be given the opportunity to design new master configurations and master adjustment paths themselves.

According to various embodiments, a control arrangement for the operation of an adjustment system for an interior of a motor vehicle is provided as such. The control arrangement implements the mentioned control while complying with the comfort specification. Reference is made to all of the statements regarding the proposed method.

According to various embodiments, a motor vehicle for carrying out the proposed method is provided as such. Reference is also made to this end to all of the statements regarding the proposed method.

According to various embodiments, a computer program product for the proposed control arrangement is provided as such. Reference is also made to this end to all of the statements regarding the further teachings.

According to various embodiments, a computer-readable medium on which the proposed computer program is stored is provided as such.

Various embodiments provide a method for operating an adjustment system for an interior of a motor vehicle, the adjustment system comprising a motor-adjustable interior element for receiving at least one body part of a person, the motor-adjustable interior element being adjustable between different configurations by way of adjustment kinematics by means of a drive arrangement with at least one actuator, a control arrangement being provided, by means of which the drive arrangement is controlled in an adjustment routine in order to adjust the motor-adjustable interior element from an initial configuration into an end configuration by way of the adjustment kinematics, wherein the control arrangement has a person model for the person received by the motor-adjustable interior element, said person model representing the body geometry and the body kinematics of the person, and also an interior element model representing the interior element geometry and the adjustment kinematics of the motor-adjustable interior element, in that the body configurations of the person that result from a motorized adjustment of the interior element are predicted by means of the control arrangement on the basis of the person model and the interior element model, and in that the control in the adjustment routine is implemented by means of the control arrangement while complying with a comfort specification for the resulting body configurations.

In various embodiments, a path planning routine is implemented by means of the control arrangement, in which path planning routine an adjustment path from the initial configuration into the end configuration while complying with the comfort specification is determined on the basis of the interior element model, in that the control in the adjustment routine is implemented by means of the control arrangement in accordance with the adjustment path determined, wherein the adjustment path in the path planning routine can be determined on the basis of a probabilistic path planning method, wherein the adjustment path can be determined on the basis of a rapidly exploring random tree and/or probabilistic roadmap method.

In various embodiments, in the path planning routine an adjustment path while complying with the comfort specification is determined on the basis of the interior element model and the adjustment path determined is optimized with regard to at least one further constraint, in particular a minimization of the adjustment time and/or the adjustment displacement, and in that the optimized adjustment path is checked for compliance with the comfort specification and, upon successful checking, is used as adjustment path in the control, wherein the determination of the adjustment path while complying with the comfort specification and the optimization with regard to the further constraint can be carried out iteratively.

In various embodiments, the comfort specification concerns at least one predicted body parameter of the body configurations, such as a relative position of body parts, in particular an angle between body parts, a velocity of body parts and/or an acceleration of body parts.

In various embodiments, the comfort specification concerns at least one predicted interaction parameter between the person and at least one object in the interior, in particular the motor-adjustable interior element, wherein the interaction parameter can indicate an orientation of body parts relative to the object and to the gravitational force, a support area of body parts on the object and/or a predicted frictional force between body parts and the object.

In various embodiments, the comfort specification contains the compliance with at least one threshold value, in particular for at least one body parameter and/or at least one interaction parameter, and/or in that the comfort specification contains the optimization of a comfort weighting assigned to the at least one body parameter and/or at least one comfort weighting assigned to the interaction parameter.

In various embodiments, person models and/or comfort specifications for different persons are or have been stored in person profiles, and in that in a personalization routine the person profile stored for the person identified as the operator of the motor vehicle is used in the adjustment routine by means of the control arrangement.

In various embodiments, an end configuration specification, in accordance with which different end configurations are allowed, is provided for the adjustment routine, and in that the control in the adjustment routine is implemented by means of the control arrangement while complying with the comfort specification into one of these allowed end configurations.

In various embodiments, the control arrangement has an obstacle representation of objects in the interior for collision checking during the adjustment, and in that in the path planning routine a collision-free adjustment path from the initial configuration into the end configuration is determined on the basis of the obstacle representation, wherein the adjustment system can have an interior sensor arrangement coupled to the control arrangement and serving for detecting objects in the interior, and in that the obstacle representation is generated by means of the control arrangement on the basis of the objects detected by way of the interior sensor arrangement.

In various embodiments, the control arrangement determines the configuration on the basis of the detection of the motor-adjustable interior element by way of the interior sensor arrangement, wherein the motor-adjustable interior element can include a marking provided for recognizing the configuration by way of the detection by the interior sensor arrangement, in particular a reflection element for light, radar and/or ultrasound.

In various embodiments, an identification of the interior elements arranged in the interior is implemented by means of the control arrangement in an identification routine, in particular by means of a detection of the interior elements by way of the interior sensor arrangement and/or by way of a recognition of an electronic marker of the interior elements by means of the control arrangement, and in that the interior element model and/or the obstacle representation are/is generated by means of the control arrangement on the basis of the identification.

In various embodiments, master configurations for the configuration of the adjustment kinematics and also master adjustment paths indicating an adjustment between master configurations are stored in the control arrangement, and in that the control in the adjustment routine is implemented at least partly on the basis of at least one of the master adjustment paths.

In various embodiments, an intermediate adjustment path between an intermediate configuration, in particular the initial configuration and/or end configuration, and one of the master configurations is determined in the path planning routine, and in that the control in the adjustment routine is implemented at least partly on the basis of the intermediate adjustment path, such as on the basis of an optimization specification of a predefined metric, the intermediate configuration is assigned to one of the master configurations for determining the intermediate adjustment path.

In various embodiments, in a learning routine a master configuration and/or a master adjustment path are/is stored, in particular by the operator of the motor vehicle, such as by way of an operator input for storing a current configuration as master configuration and/or by way of manually implemented control of the drive arrangement for creating a master adjustment path.

In various embodiments, in the path planning routine an optimization of at least one master adjustment path is implemented, in particular given the presence of a collision on the master adjustment path and/or for the purpose of complying with a constraint, wherein the optimization of the master adjustment path can be based on a probabilistic path planning method for the master configurations connected by the master adjustment path and/or on evasive switching to at least one further master adjustment path, wherein the optimized master adjustment path is stored as the new master adjustment path.

Various embodiments provide a control arrangement for the operation of an adjustment system for an interior of a motor vehicle, the adjustment system comprising a motor-adjustable interior element for receiving at least one body part of a person, the motor-adjustable interior element being adjustable between different configurations by way of adjustment kinematics by means of a drive arrangement with at least one actuator, the control arrangement controlling the drive arrangement in an adjustment routine in order to adjust the motor-adjustable interior element from an initial configuration into an end configuration by way of the adjustment kinematics, wherein the control arrangement has a person model for the person received by the motor-adjustable interior element, said person model representing the body geometry and the body kinematics of the person, and also an interior element model representing the interior element geometry and the adjustment kinematics of the motor-adjustable interior element, in that the control arrangement predicts the body configurations of the person that result from a motorized adjustment of the interior element on the basis of the person model and the interior element model, and in that the control arrangement implements the control in the adjustment routine while complying with a comfort specification for the resulting body configurations.

Various embodiments provide a motor vehicle for carrying out the method according to the disclosure.

Various embodiments provide a computer program product, comprising instructions which have the effect that a control arrangement according to disclosure is caused to control the drive arrangement in an adjustment routine in order to adjust the motor-adjustable interior element from an initial configuration into an end configuration by way of the adjustment kinematics, to predict the body configurations of the person that result from a motorized adjustment of the interior element on the basis of the person model and the interior element model and to implement the control in the adjustment routine while complying with a comfort specification for the resulting body configurations.

Various embodiments provide a computer-readable medium on which the computer program according to disclosure is stored.

### BRIEF DESCRIPTION OF THE DRAWINGS

Various aspects are explained in more detail below with reference to a drawing merely illustrating exemplary embodiments. In the drawing

FIG. 1 shows a perspective view of a proposed motor vehicle for carrying out the proposed method in a) a first configuration and b) a second configuration of the adjustment system,

FIG. 2 shows a schematic illustration of a person model and an interior element model,

FIG. 3 shows a) a schematic illustration of a motor-adjustable interior element, b) a diagram with degrees of freedom and configurations, c) a schematic illustration of configurations, and d) and e) schematic illustrations of adjustment paths between configurations.

### DETAILED DESCRIPTION

Various embodiments relate to a method for operating an adjustment system 1 for an interior 2 of a motor vehicle 3. The interior 2 is understood here as meaning the inner portion of the motor vehicle 3 which has the passenger compartment.

The interior 2 here is assigned various interior elements of the motor vehicle 3, which can be in principle static or adjustable. Static interior elements are arranged immovably relative to the rest of the motor vehicle 3. By contrast, adjustable interior elements are designed to be moved into at least two different positions relative to the rest of the motor vehicle 3. The adjustable interior elements can in principle be adjusted by motor and/or manually. For possible embodiments of the interior elements, reference is also made to the statements at the beginning.

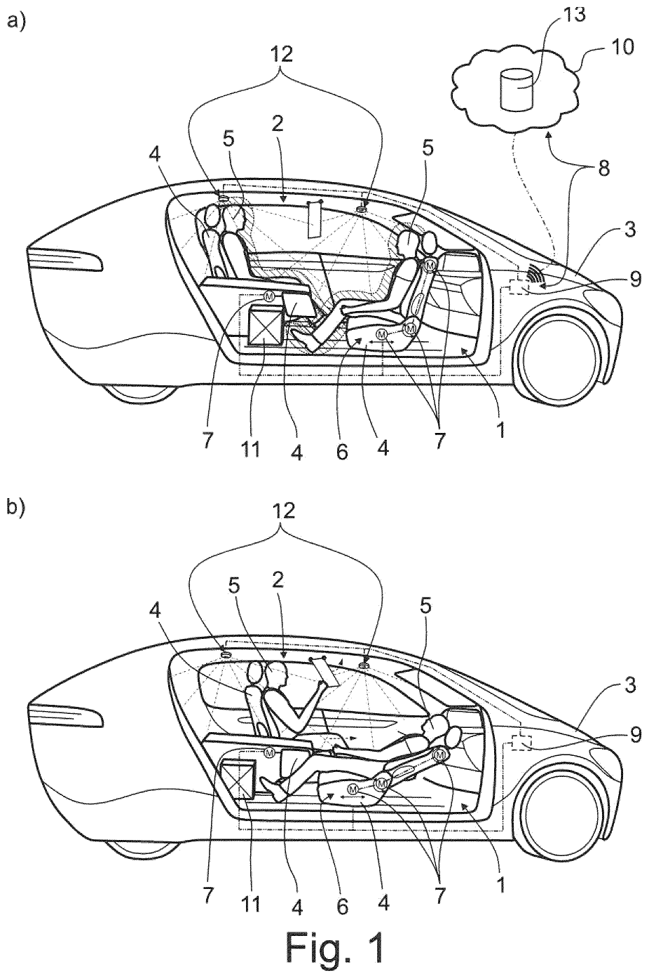

The adjustment system 1 comprises at least one motor-adjustable interior element 4 for receiving at least one body part of a person 5. The motor-adjustable interior element 4 is adjustable between different configurations by way of adjustment kinematics by means of a drive arrangement 6 with at least one actuator 7. As illustrated in FIG. 1, the motor-adjustable interior element 4 can be designed as a seat. In principle, the motor-adjustable interior element 4 can also be designed as part of a seat, for example as an armrest or a backrest. Other motor-adjustable interior elements designed for receiving at least one body part of a person 5 are likewise conceivable, for example a footrest, a handle, a tray or the like. Receiving at least one body part of the person 5 is understood to mean that the motor-adjustable interior element 4 is designed for mechanical, ergonomic contact with the person.

As is shown in FIG. 1, the adjustment system can comprise a plurality of motor-adjustable interior elements 4 for receiving persons 5, inter alia a plurality of seats. The proposed method is explained below by way of example on the basis of a single motor-adjustable interior element 4 designed as a seat. All explanations are applicable, mutatis mutandis, to further motor-adjustable interior elements 4.

The actuators 7 are generally electrically controllable actuators, for example rotary electric motors and/or electric linear motors, magnetic, pneumatic and/or hydraulic actuators or the like, which bring about a motorized adjustment of the motor-adjustable interior element 4 by way of a drive movement. Depending on the design of the motor-adjustable interior element 4, the drive arrangement 6 can comprise one actuator 7 or a plurality of actuators 7. A plurality of actuators 7 are provided in particular for implementing an adjustment in different degrees of freedom of the motor-adjustable interior element 4, for example a longitudinal adjustment, a height adjustment and a pivoting adjustment. A plurality of actuators 7 for one degree of freedom can also be provided.

The adjustment kinematics should be understood to mean the components of the adjustment system 1 and in particular of the motor-adjustable interior element 4 which allow a movement of the motor-adjustable interior element 4, for example joints, hinges, guide rails or the like.

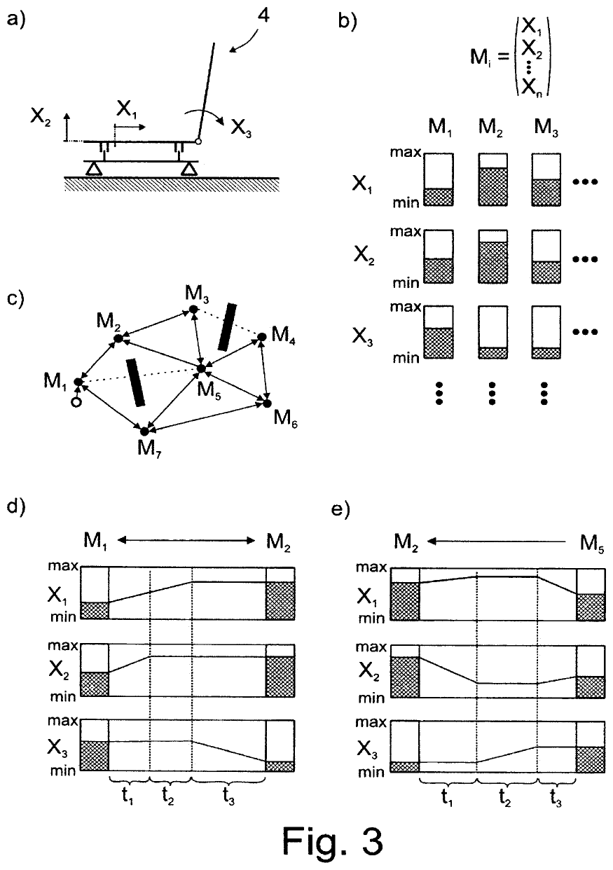

The motor-adjustable interior element 4 can be brought into different configurations Mᵢ by way of the adjustment kinematics. FIG. 3a) and FIG. 3b) show, by way of example, three degrees of freedom X₁, X₂, X₃ of the motor-adjustable interior element 4 for the configurations M₁, M₂, M₃. Here, X₁, for example, represents the position of the longitudinal adjustment of a seat, X₂ represents the position of the height adjustment of the seat, and X₃ represents the position, here the pivoting angle, of the backrest relative to the rest of the seat. Alternative or additional degrees of freedom are conceivable.

The configuration Mᵢ here specifies the entirety of the positions of the degrees of freedom X₁ . . . Xₙ of the motor-adjustable interior elements 4. The degrees of freedom X₁ . . . Xₙ here may be continuously variable and/or at least partially only assume discrete values. In the latter case, for example, only certain discrete positions of the motor-adjustable interior element 4 can be achieved, for example because of a mechanical grid system or the like. In some embodiments, the drive arrangement 6 is self-locking at least for some of the degrees of freedom, and therefore the configuration Mᵢ is maintained even without control of the drive arrangement 6.

A control arrangement 8 is provided for controlling the drive arrangement 6. The control arrangement 8, in some embodiments, has control electronics for implementing the control tasks during the motorized adjustment. In various embodiments, the control arrangement 8 has an interior controller 9, which communicates with a data server 10 via a communication network. The interior controller 9 can in turn have a plurality of decentralized components, for example a drive controller assigned to the drive arrangement 6, and/or can be integrated in a central motor vehicle controller. Likewise, the control arrangement 8, according to an embodiment that is not illustrated here, can be integrated as a whole in the motor vehicle 3.

By means of the control arrangement 8, the drive arrangement 5 is controlled in an adjustment routine in order to adjust the motor-adjustable interior element 4 from an initial configuration into an end configuration by way of the adjustment kinematics. FIG. 3b) shows different configurations M₁, M₂ . . . Mₙ, wherein the positions of the degrees of freedom X₁, X₂ . . . Xₙ can vary schematically from a minimum value to a maximum value. The positions of the degrees of freedom X₁, X₂ . . . Xₙ can be characterized by means of characteristic values, for example the adjustment displacement, the adjustment angle, the position of an incremental displacement sensor or the like.

The initial configuration represents the configuration Mᵢ present at the beginning of the adjustment routine. The end configuration is accordingly the configuration Mᵢ which is intended to be achieved with the adjustment routine. Various initial configurations and end configurations are conceivable, for example an adjustment from an upright position of the seats into a reclining position, an adjustment from an orientation of the seats in the direction of travel into a configuration of the seats with seats facing one another, folded up or unfolded trays or the like.

What is now essential is that the control arrangement 8 has a person model for the person 5 received by the motor-adjustable interior element, said person model representing the body geometry and the body kinematics of the person, and also an interior element model representing the interior element geometry and the adjustment kinematics of the motor-adjustable interior element 4.

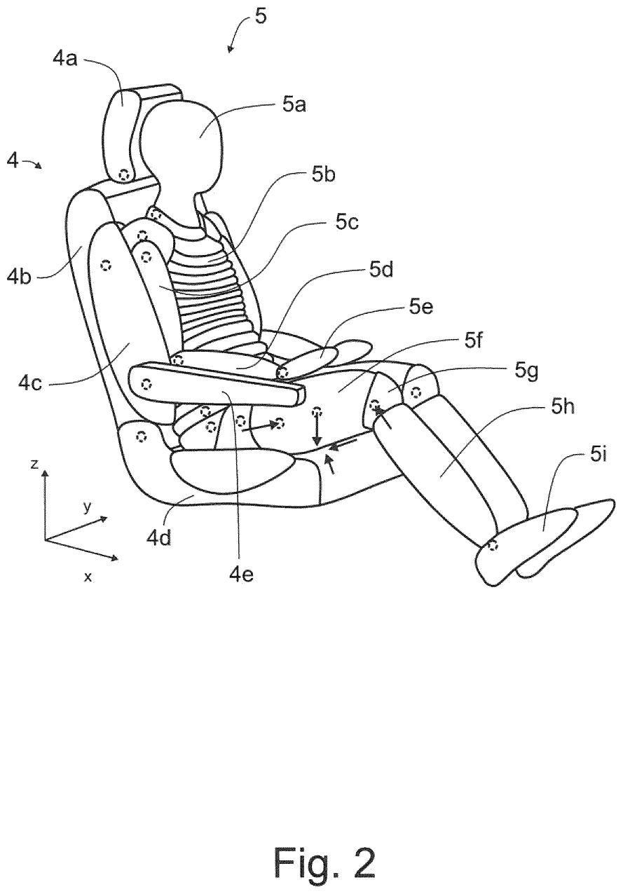

FIG. 2 schematically shows aspects of a person model of the person 5 and of an interior element model of the motor-adjustable interior element 4. The body geometry should be understood here to mean the spatial extent of the person 5. Accordingly, the interior element geometry should be understood to mean the spatial extent of the motor-adjustable interior element 4. In various embodiments, the motor-adjustable interior element 4 is subdivided into interior element segments 4a-4e and the person 5 in the person model is subdivided into body segments 5a-5i. The movement possibilities for the body of the person are modelled by the body kinematics of the person 5. By way of example, kinematics of an ankle are modelled between the body segments 5h and 5i, said kinematics reproducing the behaviour of the body under a foot movement.

What is furthermore essential is that the body configurations of the person 5 that result from a motorized adjustment of the interior element 4 are predicted by means of the control arrangement 8 on the basis of the person model and the interior element model.

In this case, use can be made of physical models known per se for the prediction of the interaction of spatial structures, which can take account of the influence of the gravitational force. In one embodiment, (quasi-) static models are used, in which intermediate configurations of the body configuration are first considered individually. The use of dynamic models is likewise conceivable. A temporal progression of a plurality of body configurations is determined overall, which is brought about by the movement sequence in the adjustment routine.

What is furthermore essential is that the control in the adjustment routine is implemented by means of the control arrangement 8 while complying with a comfort specification for the resulting body configurations.

The comfort specification generally concerns a limitation of the control in order to avoid body configurations that are to be categorized as uncomfortable and/or movements between body configurations that are to be categorized as uncomfortable. The comfort specification can be specified individually for the person 5. The comfort specification can contain an optimization of the parameters concerning comfort that arise during the adjustment routine.

In various embodiments, a path planning routine is implemented by means of the control arrangement 8, in which path planning routine an adjustment path from the initial configuration into the end configuration while complying with the comfort specification is determined on the basis of the interior element model. The control in the adjustment routine is implemented by means of the control arrangement 8 in accordance with the adjustment path determined.

In various embodiments, the path planning routine is implemented upon triggering of the adjustment routine, for example by the operator requesting a desired end configuration. Given a known initial configuration, the control arrangement 8 determines an adjustment path to the end configuration on the basis of the interior element model. In accordance with a further embodiment, the path planning routine can be implemented, in particular repeatedly, during the motorized adjustment, with an adjustment path from the present configuration as the initial configuration into the end configuration being determined.

The determined adjustment path can be depicted in a time dependence of the respective degrees of freedom X₁, X₂ . . . Xₙ, which is shown in FIGS. 3d) and e). The adjustment of individual degrees of freedom X₁, X₂ . . . Xₙ which is carried out in the adjustment routine by control of the actuator 6 assigned to the degree of freedom X₁, X₂ . . . Xₙ can be carried out by simultaneous control (in this case X₁ and X₂ in the time period t₁ in FIG. 3d)). A temporal sequence of controls can also be provided, with firstly one actuator 7 being adjusted and only then a further actuator 7 being adjusted (in this case X₂ and X₃ in FIG. 3d)). The determined adjustment path can also include reversing an actuator (in this case X₁ in FIG. 3e)).

In addition to the identification of a possible adjustment path, the path planning routine also allows optimization of the adjustment path in various possible alternatives. FIG. 3c) schematically shows different possible paths between the configurations Mᵢ. If, for example, the configuration Mᵢ is the initial configuration and the configuration M₅ is provided as the end configuration, it can be taken into consideration in the path planning routine whether the possible adjustment paths comply with the comfort specification. One of the adjustment paths complying with the comfort specification is selected for the purpose of the adjustment, in particular on the basis of a further constraint.

In various embodiments, it is provided that the adjustment path is determined in the path planning routine on the basis of a probabilistic path planning method. With probabilistic path planning methods, a significant reduction in the computational complexity that arises for determining the adjustment path can be achieved. Consequently, a significant time delay is avoided when starting the adjustment routine and, in particular, path planning in real time during the adjustment is made possible.

It has proven particularly useful here that the adjustment path is determined on the basis of a rapidly exploring random tree (RRT) method and/or probabilistic roadmap (PRM) method. These path planning methods developed inter alia for autonomous navigation and robotics are advantageously applicable here to the adjustment system 1 for a motor vehicle 3. Additionally or alternatively, it is possible to determine the adjustment path on the basis of a potential field method and/or a heuristic search method.

In the path planning routine, in various embodiments, an adjustment path while complying with the comfort specification is determined on the basis of the interior element model (step 1) and the adjustment path determined is optimized with regard to at least one further constraint (step 2). Possible constraints of the path planning routine are, in particular, a minimization of the adjustment time and/or the adjustment displacement. The optimized adjustment path is in turn checked for compliance with the comfort specification and, upon successful checking, is used as adjustment path in the control. An optimized adjustment path which satisfies the comfort specification can thereby be determined in a simple manner.

The abovementioned steps 1 and 2 for path planning can be carried out repeatedly. In particular, the determination of the adjustment path while complying with the comfort specification and the optimization with regard to the further constraint are thus carried out iteratively.

In various embodiments, the comfort specification concerns at least one predicted body parameter of the body configurations. The body parameter here is a parameter derived from the predicted body configurations. In various embodiments, the body parameter is a relative position of body parts, in particular an angle and/or a distance between body parts. The body parts here can correspond to the body segments 5a-5i shown in FIG. 2. One example of such an angle here is the angle of the ankle between the body segments 5h and 5i in FIG. 2. The distance between body parts can be representative of the extent to which a body part is stretched and/or whether body parts touch one another. Further possible body parameters concern a velocity of body parts and/or an acceleration of body parts, which can be determined from the time dependence of the predicted body configuration.

In accordance with a further embodiment, the comfort specification concerns at least one predicted interaction parameter between the person 5 and at least one object in the interior 2. The object is the motor-adjustable interior element 4, in particular. However, it is also conceivable for the interaction parameter to be defined between the person 5 and a further object which is in mechanical contact with the person 5 or comes into mechanical contact with the person 5 in the adjustment routine. Examples thereof are the floor of the interior 2 and static interior elements such as static armrests or the like.

In various embodiments, the interaction parameter concerns an orientation of body parts relative to an object, in particular to the motor-adjustable interior element 4, and to the gravitational force. The interaction parameter here is representative of the manner of support of the person 5 by the object. By way of example, an extreme inclination of a part of the seat may lead to a lack of support for the person 5.

In various embodiments, the interaction parameter concerns a support area of body parts on the motor-adjustable interior element 4. A support area should be understood to mean the magnitude of the contact area between the motor-adjustable interior element 4 and the person 5. In particular, the support area can be variable in the adjustment, in which case excessively small support areas would lead to a loss of comfort.

In various embodiments, the interaction parameter concerns a predicted frictional force between body parts and the object. In particular, here friction values of the surface material of the object may be known and the friction effects that arise with respect to the body parts can be estimated. In this case, friction values of the body parts may in turn be previously known or can be estimated on the basis of specifications, for example depending on whether the body part is a clothed body part or there is contact with the skin. In particular, the requirements in respect of the interaction parameter are also specified differently depending on what body part is in contact with the object. By way of example, possible shifting of clothing on account of friction effects may be assessed differently from a friction effect on the skin of the person 5 in the comfort specification.

In various embodiments, the comfort specification contains the compliance with at least one threshold value, in particular for at least one body parameter and/or at least one interaction parameter. The threshold values can be, in principle, minimum or maximum values for parameters of the body configuration, whereby undergoing certain body configurations that are to be categorized as uncomfortable in the adjustment routine is precluded with a high level of certainty.

The comfort specification can also contain the optimization of a comfort weighting assigned to the at least one body parameter and/or at least one comfort weighting assigned to the interaction parameter. The comfort weighting here represents a (relative) measure of the comfort perceived with the parameter of the body configuration. By way of example, uncomfortable body configurations acquire a lower comfort weighting than comfortable body configurations. The comfort specification, particularly in the path planning, here strives to maximize the entire comfort weighting. Therefore, in contrast to the threshold values, undergoing uncomfortable body configurations is not totally precluded. However, uncomfortable body configurations tend to be undergone to a lesser extent and/or more quickly, for example. In the present case, the assignment of comfort weightings can also be combined with threshold values.

In accordance with various embodiments, person models and/or comfort specifications for different persons 5 are or have been stored in person profiles. In a personalization routine, the person profile stored for the person 5 identified as the operator of the motor vehicle 3 is used in the adjustment routine by means of the control arrangement 8. The person profiles here can be stored in a memory of the control arrangement 8, the person 10 being identified for example with the aid of an identification unit, for example an electronic key or a mobile device, such as a mobile telephone, carried by the person 5. A person profile can likewise be stored in a memory of the identification unit and be read out by the control arrangement 8.

The end configuration for the path planning routine does not necessarily have to be defined for all of the degrees of freedom X₁, X₂ . . . Xₙ. In various embodiments, an end configuration specification, in accordance with which different end configurations are allowed, is provided for the adjustment routine. The control is implemented while complying with the comfort specification into one of these allowed end configurations. In this case, individual degrees of freedom X₁, X₂ . . . Xₙ can be left open in the end configuration specification as a whole. Permitted ranges for degrees of freedom X₁, X₂ . . . Xₙ can also be provided. For example, a reclining position of the seats can be provided as an end configuration specification, but the angle of rotation of the seats is left open. The selection of the end configuration can also be implemented on the basis of the comfort specification, the end configuration being chosen in such a way as to optimize comfort in the adjustment routine as a whole.

In various embodiments, the control arrangement 8 has an obstacle representation of objects in the interior 2 for collision checking during the adjustment. Objects in the interior 2 which can be depicted in the obstacle representation are understood to mean the interior elements, in particular the motor-adjustable interior elements 4, the persons 5 located in the interior and/or articles 11 located in the interior 2. In the path planning routine a collision-free adjustment path from the initial configuration into the end configuration is determined on the basis of the obstacle representation. The control in the adjustment routine is implemented by means of the control arrangement 8 in accordance with the collision-free adjustment path determined.

In addition to the relevance of the path planning for avoiding collisions with articles 11, avoidance of collisions among the interior elements 4 can also be brought about here. In various embodiments, the adjustment kinematics allow a plurality of motor-adjustable interior elements 4 to overlap one another during the adjustment movement, and therefore coordination of the adjustment routine is particularly important.

In accordance with the illustrated and various embodiments, the adjustment system 1 has an interior sensor arrangement 12 coupled to the control arrangement 8 and serving for detecting objects in the interior 2. The interior sensor arrangement 12, in various embodiments, is designed for detecting persons 5 in the interior 2, articles 11 in the interior 2 and/or the motor-adjustable interior element 4. The interior sensor arrangement 12 can in this case comprise at least one radar sensor, optical sensor, for example an imaging sensor, such as a camera, in particular a ToF camera and/or 3D camera, an acoustic sensor, for example an ultrasonic sensor. Also, the interior sensor arrangement 12 can comprise a seat occupancy sensor, a capacitive sensor or the like, which makes it possible to draw a conclusion about the presence of an object in the interior 2.

In various embodiments, the person model is generated on the basis of the detection of the person 5 by means of the interior sensor arrangement 12. By way of example, it is provided that the objects detected by the interior sensor arrangement 12 are classified by means of the control arrangement. The person model is selected, on the basis of a model assigned to the respective object class of the detected person 5.

Different classifications of objects can also be predetermined here for different sensors of the interior sensor arrangement 12. For example, imaging sensors of the interior sensor arrangement 12 can permit classification of the object on the basis of an image recognition method such that the three-dimensional shape of the object, in particular of the person 5, can be depicted with a high degree of accuracy. On the basis of weight information of a person 5 that is detected by way of the interior sensor arrangement 12, it is possible, on the basis of predetermined, average person models, for approximately the three-dimensional shape of the person 5 to be modelled. In the case of a seat occupancy sensor, which merely reflects the presence of a person 5, the person model can in turn be predetermined on the basis of average values, which are defined, for example, in a country-specific manner.

By means of the control arrangement 8, in various embodiments, the obstacle representation is generated, on the basis of the objects detected by way of the interior sensor arrangement. Consequently, the instantaneous state of the interior 2, for example regarding the presence and/or position of persons 5 and/or articles 11, can also be taken into consideration in the path planning routine.

In accordance with a further embodiment, the configuration is determined by means of the control arrangement 8 on the basis of the detection of the motor-adjustable interior element 4 by way of the interior sensor arrangement 12. Generally, the configuration, in particular the initial configuration, can be at least partially determined on the basis of the objects detected by way of the interior sensor arrangement 12, in particular the position of the degrees of freedom of the adjustment kinematics being determined by means of the detection by way of the interior sensor arrangement 12. The interior sensor arrangement 12 can also be used to validate an already known configuration, which is determinable, for example, on the basis of the positions of the actuators 7.

In accordance with a further embodiment, the motor-adjustable interior element 4 comprises a marking provided for recognizing the configuration by way of the detection by the interior sensor arrangement 12. In this case, the marking is coordinated with simple and accurate recognition by way of sensors of the interior sensor arrangement 12. In particular, a reflection element for light, radar and/or ultrasound can be used as a marking.

In principle, the proposed method can be used for interiors 2 with various combinations of interior elements. In this case, it is also possible for interior elements to be added, replaced and/or removed during the operation of the motor vehicle 3. In accordance with various embodiments, an identification of the interior elements arranged in the interior 2 is implemented by means of the control arrangement 8 in an identification routine.

The identification can be effected by means of a detection of the interior elements by way of the interior sensor arrangement 12. By way of example, in one embodiment, the interior 2 is examined for the presence of various previously known interior elements by way of image recognition. The identification can likewise be implemented by way of a recognition of an electronic marker of the interior elements by means of the control arrangement 8. It is conceivable for the interior element, in particular the motor-adjustable interior element 4, to be equipped with an electronic marker such as an RFID chip or the like, which is read by the control arrangement 8 wirelessly and/or in a wired manner. The obstacle representation and/or the interior element model are/is generated by means of the control arrangement 8, on the basis of the identification.

By means of the control arrangement 8, a database of interior element models of predefined interior elements can be used in the identification routine. It is conceivable here for the database to be stored at least partly in an electronic memory integrated in the interior element. An interior element added to the interior 2 can thus provide the information for the path planning itself, whereby it is also possible to use individually designed interior elements. By way of example, the electronic marker of the interior element comprises such an electronic memory.

The database can also be stored at least partly in a memory 13 of the control arrangement. The database can contain, for example, interior element models of the interior elements available for the motor vehicle type. In various embodiments, the memory 13 is assigned to the data server 10, which allows for example cloud-based management of the models for a multiplicity of motor vehicles 3.

The identification routine can be triggered upon vehicle operation being started, for example when the motor vehicle 3 is unlocked and/or when the drive motor of the motor vehicle 3 is started. Likewise, the identification routine can be triggered upon detection of an added and/or exchanged interior element by means of the interior sensor arrangement 12. Furthermore, the identification routine can be triggered upon mounting/demounting of interior elements, for example by manual triggering or detection of maintenance by way of the central motor vehicle controller. Furthermore, provision can be made for the identification routine to be triggered in a time-controlled manner, for example at regular, predetermined time intervals.

In various embodiments, and in particular by means of the control arrangement 8, the detection of objects by way of the interior sensor arrangement 12 is triggered upon a start of vehicle operation, an actuation of a flap of the motor vehicle 3, with triggering of the identification routine and/or in a time-controlled manner. An actuation of a flap is understood here to mean an active or passive operator action which is exerted on a flap such as a door, bonnet or tailgate of the motor vehicle 3. Examples of an operator action are unlocking or opening of the flap.

In various embodiments, the time-controlled triggering is implemented cyclically and/or on the basis of a probability of recognition of objects. The probability of recognition can be the result of an image recognition routine, for example. If the probability of recognition is low, for example, the detection of an object can be repeated, in particular at shortened time intervals, until assured detection of the object is present.

In various embodiments, master configurations for the configuration and also master adjustment paths indicating an adjustment between master configurations are stored in the control arrangement 8. The control in the adjustment routine is implemented at least partly on the basis of at least one of the master adjustment paths.

By way of example, the configurations M₁ . . . M₇ shown in FIG. 3c) are predetermined master configurations, for the connection of which master adjustment paths are predefined. In the path planning routine, too, the control arrangement 8 can make use of individual master adjustment paths in order to determine a collision-free adjustment path. In particular, the adjustment path between two master configurations can be given by a master adjustment path (e.g. M₁ to M₂). If a master adjustment path is not collision-free, it is also possible to make use of a combination of master adjustment paths (e.g. M₁ to M₅ via M₂ or M₇). The respective combination of master adjustment paths can in turn be selected on the basis of constraints, for example a minimized adjustment displacement.

In this case, the master configurations and master adjustment paths can be designed and calculated beforehand. By way of example, the master adjustment paths are adjustment paths which are generated with an increased computing power between predetermined master configurations while complying with the comfort specification and while optimizing constraints. Therefore, the master adjustment paths can be predetermined or precalculated adjustment paths which satisfy the comfort specification. In a further embodiment, the person profiles can contain master configurations and/or master adjustment paths, such that these can be embodied individually for the respective person 5.

In various embodiments, it is additionally provided that an intermediate adjustment path between an intermediate configuration Z, which can be in particular the initial configuration and/or the end configuration, and one of the master configurations is determined in the path planning routine. The adjustment path is determined at least partly on the basis of the intermediate adjustment path.

In FIG. 3c), for example, the initial configuration is such an intermediate configuration Z which does not correspond to any of the master configurations. The control arrangement 8 can generate an intermediate adjustment path, here from the intermediate configuration Z into the master configuration M₁. In this case, on the basis of an optimization specification of a predefined metric, the intermediate configuration Z can be assigned to one of the master configurations for determining the intermediate adjustment path. By way of example, the intermediate configuration Z is assigned the master configuration with the smallest distance in a predetermined metric, such as the I₁ or I₂ metric. The intermediate adjustment path is determined by way of a probabilistic path planning method, for example, while the further adjustment path is determined at least partly on the basis of the master adjustment paths.

In various embodiments, in a learning routine a master configuration and/or a master adjustment path are/is stored, in particular by the operator of the motor vehicle 3. In various embodiments, the storage is effected by way of an operator input for storing a current configuration as master configuration. The operator can for example manually design the configuration and store the configuration thereby achieved as master configuration by way of an operator input. A master adjustment path can be created in particular by way of manually implemented control of the drive arrangement 6. The operator can activate the learning routine and subsequently implement a manual adjustment which is stored as master adjustment path.

In the path planning routine an optimization of at least one master adjustment path can likewise be implemented. In particular given the presence of a collision on the master adjustment path and/or for the purpose of complying with the comfort specification, in the path planning routine it is possible to depart from the master adjustment path, in which case the master adjustment path is used for example as a starting point for the path planning. In various embodiments, the optimization of the master adjustment path is based on a probabilistic path planning method for the master configurations connected by the master adjustment path. For optimization purposes, in particular given the presence of a collision, evasive switching to at least one further master adjustment path can be implemented. In various embodiments, the optimized master adjustment path is stored as the new master path, such that the optimized master adjustment path is available for future path planning routines.

In accordance with a further teaching having independent significance, a control arrangement 8 for the operation of an adjustment system 1 for an interior 2 of a motor vehicle 3 is provided as such. The adjustment system 1 comprises a motor-adjustable interior element 4 for receiving at least one body part of a person 5, the motor-adjustable interior element 4 being adjustable between different configurations by way of adjustment kinematics by means of a drive arrangement 6 with at least one actuator 7. The control arrangement 8 controls the drive arrangement 6 in an adjustment routine in order to adjust the motor-adjustable interior element 4 from an initial configuration into an end configuration by way of the adjustment kinematics.

What is essential is that the control arrangement 8 has a person model for the person 5 received by the motor-adjustable interior element, said person model representing the body geometry and the body kinematics of the person 5, and also an interior element model representing the interior element geometry and the adjustment kinematics of the motor-adjustable interior element, that the control arrangement 8 predicts the body configurations of the person that result from a motorized adjustment of the interior element on the basis of the person model and the interior element model, and that the control arrangement 8 implements the control in the adjustment routine while complying with a comfort specification for the resulting body configurations. Reference is made to all of the statements regarding the proposed method.

In accordance with a further teaching likewise having independent significance, a motor vehicle 3 for carrying out a proposed method is provided as such. In this respect, too, reference is made to all of the statements regarding the proposed method.

In various embodiments, a computer program product is provided. The computer program product comprises instructions which have the effect that the proposed control arrangement 8 is caused to control the drive arrangement 6 in an adjustment routine in order to adjust the motor-adjustable interior element 4 from an initial configuration into an end configuration by way of the adjustment kinematics, to predict the body configurations of the person 5 that result from a motorized adjustment of the interior element on the basis of the person model and the interior element model and to implement the control in the adjustment routine while complying with a comfort specification for the resulting body configurations. In various embodiments, the control arrangement 8 comprises a memory in which the computer program product is stored, and also a processor for processing the instructions.

The computer program product comprises instructions which have the effect that the proposed motor vehicle carries out the proposed method. Reference is made to all of the above statements regarding the further teachings.

A computer-readable medium on which the proposed computer program is stored, such as in a non-volatile manner, is furthermore provided.

1. A method for operating an adjustment system for an interior of a motor vehicle,
the adjustment system comprising a motor-adjustable interior element for receiving at least one body part of a person, the motor-adjustable interior element being adjustable between different configurations by way of adjustment kinematics by a drive arrangement with at least one actuator,
a control arrangement being provided, by which the drive arrangement is controlled in an adjustment routine in order to adjust the motor-adjustable interior element from an initial configuration into an end configuration by way of the adjustment kinematics,
wherein the control arrangement has a person model for the person received by the motor-adjustable interior element, said person model representing the body geometry and the body kinematics of the person, and also an interior element model representing the interior element geometry and the adjustment kinematics of the motor-adjustable interior element, in that the body configurations of the person that result from a motorized adjustment of the interior element are predicted by the control arrangement on the basis of the person model and the interior element model, and in that the control in the adjustment routine is implemented by the control arrangement while complying with a comfort specification for the resulting body configurations.

2. The method according to claim 1, wherein a path planning routine is implemented by the control arrangement, in which path planning routine an adjustment path from the initial configuration into the end configuration while complying with the comfort specification is determined on the basis of the interior element model, in that the control in the adjustment routine is implemented by the control arrangement in accordance with the adjustment path determined.

3. The method according to claim 2, wherein in the path planning routine an adjustment path while complying with the comfort specification is determined on the basis of the interior element model and the adjustment path determined is optimized with regard to at least one further constraint, and in that the optimized adjustment path is checked for compliance with the comfort specification and, upon successful checking, is used as adjustment path in the control.

4. The method according to claim 1, wherein the comfort specification concerns at least one predicted body parameter of the body configurations.

5. The method according to claim 1, wherein the comfort specification concerns at least one predicted interaction parameter between the person and at least one object in the interior.

6. The method according to claim 1, wherein the comfort specification contains the compliance with at least one threshold value, and/or in that the comfort specification contains the optimization of a comfort weighting assigned to the at least one body parameter and/or at least one comfort weighting assigned to the interaction parameter.

7. The method according to claim 1, wherein person models and/or comfort specifications for different persons are or have been stored in person profiles, and in that in a personalization routine the person profile stored for the person identified as the operator of the motor vehicle is used in the adjustment routine by the control arrangement.

8. The method according to claim 1, wherein an end configuration specification, in accordance with which different end configurations are allowed, is provided for the adjustment routine, and in that the control in the adjustment routine is implemented by the control arrangement while complying with the comfort specification into one of these allowed end configurations.

9. The method according to claim 1, wherein the control arrangement has an obstacle representation of objects in the interior for collision checking during the adjustment, and in that in the path planning routine a collision-free adjustment path from the initial configuration into the end configuration is determined on the basis of the obstacle representation.

10. The method according to claim 9, wherein the control arrangement determines the configuration on the basis of the detection of the motor-adjustable interior element by way of the interior sensor arrangement.

11. The method according to claim 1, wherein an identification of the interior elements arranged in the interior is implemented by the control arrangement in an identification routine, and in that the interior element model and/or the obstacle representation are/is generated by the control arrangement on the basis of the identification.

12. The method according to claim 1, wherein master configurations for the configuration of the adjustment kinematics and also master adjustment paths indicating an adjustment between master configurations are stored in the control arrangement, and in that the control in the adjustment routine is implemented at least partly on the basis of at least one of the master adjustment paths.

13. The method according to claim 12, wherein an intermediate adjustment path between an intermediate configuration and one of the master configurations is determined in the path planning routine, and in that the control in the adjustment routine is implemented at least partly on the basis of the intermediate adjustment path.

14. The method according to claim 12, wherein in a learning routine a master configuration and/or a master adjustment path are/is stored.

15. The method according to claim 12, wherein in the path planning routine an optimization of at least one master adjustment path is implemented.

16. A control arrangement for the operation of an adjustment system for an interior of a motor vehicle, the adjustment system comprising a motor-adjustable interior element for receiving at least one body part of a person, the motor-adjustable interior element being adjustable between different configurations by way of adjustment kinematics by a drive arrangement with at least one actuator,
the control arrangement controlling the drive arrangement in an adjustment routine in order to adjust the motor-adjustable interior element from an initial configuration into an end configuration by way of the adjustment kinematics,
wherein the control arrangement has a person model for the person received by the motor-adjustable interior element, said person model representing the body geometry and the body kinematics of the person, and also an interior element model representing the interior element geometry and the adjustment kinematics of the motor-adjustable interior element, in that the control arrangement predicts the body configurations of the person that result from a motorized adjustment of the interior element on the basis of the person model and the interior element model, and in that the control arrangement implements the control in the adjustment routine while complying with a comfort specification for the resulting body configurations.

17. A motor vehicle for carrying out the method according to claim 1.

18. A computer program product, comprising instructions which have the effect that a control arrangement according to claim 16 is caused to control the drive arrangement in an adjustment routine in order to adjust the motor-adjustable interior element from an initial configuration into an end configuration by way of the adjustment kinematics,
to predict the body configurations of the person that result from a motorized adjustment of the interior element on the basis of the person model and the interior element model and to implement the control in the adjustment routine while complying with a comfort specification for the resulting body configurations.

19. A computer-readable medium on which the computer program according to claim 18 is stored.

20. The method according to claim 1, wherein a path planning routine is implemented by the control arrangement, in which path planning routine an adjustment path from the initial configuration into the end configuration while complying with the comfort specification is determined on the basis of the interior element model, in that the control in the adjustment routine is implemented by the control arrangement in accordance with the adjustment path determined, in that the adjustment path in the path planning routine is determined on the basis of a probabilistic path planning method, in that the adjustment path is determined on the basis of a rapidly exploring random tree and/or probabilistic roadmap method.
